(19) United States
(12) Patent Application Publication
(10) Pub. No.: US 2026/0120918 A1
(43) Pub. Date: Apr. 30, 2026

(54) WATER-RESISTANT PARALLEL CABLE SYSTEMS AND METHODS

(71) Applicant: Priority Wire & Cable, Inc., Chesapeake, VA (US)

(72) Inventor: Bang Wei Yu, Chesapeake, VA (US)

(21) Appl. No.: 19/279,956

(22) Filed: Jul. 24, 2025

Related U.S. Application Data
(60) Provisional application No. 63/713,275, filed on Oct. 29, 2024.

(51) Int. Cl. H01B 7/282; H01B 3/42; H01B 7/02; H01B 13/06; H01B 13/22

(52) U.S. Cl. CPC H01B 7/2825; H01B 3/422; H01B 7/02; H01B 13/06; H01B 13/22

(57) ABSTRACT

An electrical cable, including: a conductor set including: a first insulated conductor; a second insulated conductor; and a ground conductor, the first insulated conductor, the second insulated conductor, and the ground conductor arranged with the ground conductor positioned between the first insulated conductor and the second insulated conductor; and a jacket disposed about the conductor set, the jacket including: a central portion proximate the ground conductor; outer portions proximate the first insulated conductor and the second insulated conductor; and intermediate portions extending between the central portion and the outer portions, the central portion having a first thickness, the outer portions having a second thickness, and the first thickness being less than the second thickness, and the intermediate portions including depressions defining necked sections between the central portion and the outer portions.

### RELATED APPLICATIONS

This application claims benefit of and priority to U.S. Patent Application No. 63/713,275 filed on Oct. 29, 2024, and titled “WATER-RESISTANT PARALLEL CABLE SYSTEMS AND METHODS,” which is hereby incorporated by reference in its entirety.

### FIELD

Embodiments relate generally to electrical cables and more particularly to water-resistant electrical cables.

### BACKGROUND

Direct Current (DC) and Alternating Current (AC) Electrical cables are employed in a variety of applications to transfer electrical power or signals. An electrical cable typically includes one or more conductor wires designed to carry electric current along the cable. The conductor wires are usually formed of solid or stranded wire, made from an electrically conductive material, such as aluminum or copper. Stranded wire generally includes smaller individual wires twisted together to produce larger wires and is often more flexible than solid wires of similar size.

DC and AC Electrical cables used for photovoltaic distribution (often referred to as “PV Cable”) typically include insulated conductor wires that are installed between photovoltaic power systems. These types of electrical cables are typically formed of stranded wire, made of aluminum or copper. Aluminum conductors are commonly used due to aluminum's relatively low cost and lightweight properties compared to similarly conductive copper conductors. Copper conductors are also used in some cases due to copper's relatively high electrical conductivity compared to similarly sized aluminum conductors. A common example of a conductor used in electrical distribution or transmission lines is the 8000-series aluminum alloy conductor.

### SUMMARY

Although traditional photovoltaic (PV) cables used for electric power transmission and distribution can be suitable for use in certain conditions, they may not be suitable for use in relatively harsh conditions. For example, submersion and long-term exposure to water can lead to water absorption, which may alter the dielectric strength and cause the insulation to breakdown over time, which can cause faults in the cable system.

Recognizing these and other shortcomings of PV cables, provided are embodiments of electrical cables and associated methods. In some embodiments, a water-resistance (WR) PV cable is constructed of two phase conductors (e.g., copper or aluminum phase conductors) with a ground conductor (e.g., a copper or aluminum ground conductor) and a durable, water-resistant outer covering, with the components assembled in a flat-parallel configuration with the ground conductor located between (and in parallel with) the two phase conductors and the outer covering having intermediate portions extending between the ground and phase conductors, which may include necked areas, perforated areas, or the like. In some embodiments, the outer covering includes insulation disposed about the conductors and a jacket disposed about the insulation. For example, the outer covering may include a layer of insulation (e.g., formed of cross-linked polyethylene (XLPE)) disposed about each of the ground conductor, the first phase conductor and the second phase conductor, and a jacket (e.g., formed of polyethylene (PE)) disposed about the three insulated conductors. In such an embodiment, the jacket may effectively protect the conductors and hold the conductors in their respective positions relative to one another. For example, the three insulated conductors may be positioned in a flat-parallel configuration with the ground conductor located between (and parallel to) the phase conductors, and the PE jacket may be extruded about the insulated conductors to “fix” the positions of the insulated conductors in the flat configuration and form a durable jacket that protects the insulated conductors from the surrounding environment. In some embodiments, the jacket includes intermediate portions extending between the central and outer portions that are proximate the ground and phase conductors, respectively, including necked areas, perforated areas, or the like. For example, the extrusion of the jacket material may include forming necked portions extending between the jacketing about each of the two outside phase conductors and the central ground conductor, and perforating the jacket material of the intermediate portions with holes extending generally transverse to the longitudinal axis of the wires of the cable such that the intermediate portions form a jacket webbing extending between the jacketing of the two outside phase conductors and the central ground conductor.

Such a configuration may provide a relatively flat, durable PV cable that is suitable for use in harsh conditions, such as UV exposure, extreme temperatures, moisture, fluid submersion, and the like that are often associated with photovoltaic power system locations. For example, it may provide a PV cable that is resistant to UV, temperature, chemicals, water, and mold/mildew, and can be stacked with other similar PV cables, features a relatively small bend radius, and is relatively easy to secure and mount. Resistance to environmental conditions may, for example, enable the cable to be used in sun-exposed, hot, cold, wet, and pressure prone environments, such as burial or underwater installations. The flat configuration may improve the heat dissipation condition with the maintained spacing between the conductors. A relatively small bend radius may facilitate handling of the cable, bending it into desired shapes, routing it along specific paths, and requiring less space. A perforated intermediate portion may help make the cable relatively easier to install and secure, such as by inserting hooks, ties, screws, or other fasteners through the perforations.

Provided in some embodiments is a water-resistant jacketed paralleled electrical cable, including: a conductor set including: a first insulated conductor; a second insulated conductor; and an insulated ground conductor, the first insulated conductor, the second insulated conductor, and the ground conductor arranged in a flat-parallel adaptation, with the ground conductor positioned between the first insulated conductor and the second insulated conductor; and a water-resistant jacket disposed about the conductor set, the water-resistant jacket including: a central portion proximate the ground conductor; outer portions proximate the first insulated conductor and the second insulated conductor; and intermediate portions extending between the central portion and the outer portions, the central portion having a first thickness, the outer portions having a second thickness, and the first thickness being less than the second thickness, and the intermediate portions including depressions defining necked sections between the central portion and the outer portions.

In some embodiments, the first insulated conductor and the second insulated conductor each include: a conductor wire; and an inner insulation layer formed of a cross-linked polyethylene (XLPE) disposed about the wire, and where the water-resistant jacket is formed of polyethylene (PE) disposed about the first insulated conductor, the second insulated conductor, and the ground conductor. In some embodiments, the ground conductor includes: a conductor wire; and an inner insulation layer formed of a cross-linked polyethylene (XLPE) disposed about the wire. In some embodiments, the PE is extruded about the XLPE. In some embodiments, the intermediate portions of the water-resistant jacket include holes disposed along a length of the intermediate portions.

Provided in some embodiments is an electrical cable, including: a conductor set including: a first insulated conductor; a second insulated conductor; and a ground conductor, the first insulated conductor, the second insulated conductor, and the ground conductor arranged with the ground conductor positioned between the first insulated conductor and the second insulated conductor; and a jacket disposed about the conductor set, the jacket including: a central portion proximate the ground conductor; outer portions proximate the first insulated conductor and the second insulated conductor; and intermediate portions extending between the central portion and the outer portions, the central portion having a first thickness, the outer portions having a second thickness, and the first thickness being less than the second thickness, and the intermediate portions including depressions defining necked sections between the central portion and the outer portions.

In some embodiments, the first insulated conductor and the second insulated conductor each include: a conductor wire; and an inner insulation layer formed of a cross-linked polyethylene (XLPE) disposed about the wire, and where the water-resistant jacket is formed of polyethylene (PE) disposed about the first insulated conductor, the second insulated conductor, and the ground conductor. In some embodiments, the ground conductor includes: a conductor wire; and an inner insulation layer formed of a cross-linked polyethylene (XLPE) disposed about the wire. In some embodiments, the PE is extruded about the XLPE. In some embodiments, the intermediate portions of the jacket include holes disposed along a length of the intermediate portions. In some embodiments, the ground conductor includes an insulated ground wire. In some embodiments, the jacket includes a water-resistant jacket.

Provided in some embodiments is a method of forming an electrical cable including: insulating a first conductor wire to form a first insulated conductor; insulating a second conductor wire to form a second insulated conductor; and arranging the first insulated conductor, the second insulated conductor, and a ground conductor with the ground conductor positioned between the first insulated conductor and the second insulated conductor to form a conductor set; and disposing a jacket about the conductor set, the jacket including: a central portion proximate the ground conductor; outer portions proximate the first insulated conductor and the second insulated conductor; and intermediate portions extending between the central portion and the outer portions, the central portion having a first thickness, the outer portions having a second thickness, and the first thickness being less than the second thickness, and the intermediate portions including depressions defining necked sections between the central portion and the outer portions.

In some embodiments, insulating the first conductor wire includes disposing cross-linked polyethylene (XLPE) about the first conductor wire, where insulating the second conductor wire includes disposing XLPE about the second conductor wire, and where disposing a jacket about the conductor set includes disposing polyethylene (PE) about the first insulated conductor, the second insulated conductor, and the ground conductor. In some embodiments, the ground conductor includes: a conductor wire; and an inner insulation layer formed of a cross-linked polyethylene (XLPE) disposed about the wire. In some embodiments, the PE is extruded about the XLPE. In some embodiments, the method further includes forming holes along a length of the intermediate portions. In some embodiments, the ground conductor includes an insulated ground wire. In some embodiments, the jacket includes a water-resistant jacket.

Although certain embodiments are described in the context of use with PV systems, embodiments may be employed in any suitable context, such as for other types of conductive cabling.

### BRIEF DESCRIPTION OF THE DRAWINGS

FIGS. 1A and 1B are diagrams that illustrate a water-resistant parallel photovoltaic (WRPPV) cable in accordance with one or more embodiments.

FIGS. 2A and 2B are diagrams that illustrate positioning of WRPPV cables in accordance with one or more embodiments.

FIG. 3 is a flowchart diagram that illustrates a method of manufacturing a WRPPV cable in accordance with one or more embodiments.

While this disclosure is susceptible to various modifications and alternative forms, specific embodiments are shown by way of example in the drawings and will be described in detail. The drawings may not be to scale. It should be understood that the drawings and the detailed descriptions are not intended to limit the disclosure to the particular form disclosed, but are intended to disclose modifications, equivalents, and alternatives falling within the spirit and scope of the present disclosure as defined by the claims.

### DETAILED DESCRIPTION

Provided are embodiments of electrical cables and associated methods. In some embodiments, a water-resistance (WR) PV cable is constructed of two phase conductors (e.g., copper or aluminum phase conductors) with a ground conductor (e.g., a copper or aluminum ground conductor) and a durable, water-resistant outer covering, with the components assembled in a flat-parallel configuration with the ground conductor located between (and in parallel with) the two phase conductors and the outer covering having intermediate portions extending between the ground and phase conductors, which may include necked areas, perforated areas, or the like. In some embodiments, the outer covering includes insulation disposed about the conductors and a jacket disposed about the insulation. For example, the outer covering may include a layer of insulation (e.g., formed of cross-linked polyethylene (XLPE)) disposed about each of the ground conductor, the first phase conductor and the second phase conductor, and a jacket (e.g., formed of polyethylene (PE) disposed about the three insulated conductors. In such an embodiment, the jacket may effectively protect the conductors and hold the conductors in their respective positions relative to one another. For example, the three insulated conductors may be positioned in a flat-parallel configuration with the ground conductor located between (and parallel to) the phase conductors, and the PE jacket may be extruded about the insulated conductors to “fix” the positions of the insulated conductors in the flat configuration and form a durable jacket that protects the insulated conductors from the surrounding environment. In some embodiments, the jacket includes intermediate portions extending between the central and outer portions that are proximate the ground and phase conductors, respectively, including necked areas, perforated areas, or the like. For example, the extrusion of the jacket material may include forming necked portions extending between the jacketing about each of the two outside phase conductors and the central ground conductor, and perforating the jacket material of the intermediate portions with holes extending generally transverse to the longitudinal axis of the wires of the cable such that the intermediate portions form a jacket webbing extending between the jacketing of the two outside phase conductors and the central ground conductor.

Such a configuration may provide a relatively flat, durable PV cable that is suitable for use in harsh conditions, such as UV exposure, extreme temperatures, moisture, fluid submersion, and the like that are often associated with photovoltaic power system locations. For example, it may provide a PV cable that is resistant to UV, temperature, chemicals, water, and mold/mildew, and can be stacked with other similar PV cables, features a relatively small bend radius, and is relatively easy to secure and mount. Resistance to environmental conditions may, for example, enable the cable to be used in sun-exposed, hot, cold, wet, and pressure prone environments, such as burial or underwater installations. The flat configuration may improve the heat dissipation condition with the maintained spacing between the conductors. A relatively small bend radius may facilitate handling of the cable, bending it into desired shapes, routing it along specific paths, and requiring less space. A perforated intermediate portion may help make the cable relatively easier to install and secure, such as by inserting hooks, ties, screws, or other fasteners through the perforations.

Although certain embodiments are described in the context of use with PV systems, embodiments may be employed in any suitable context, such as for other types of electrical cabling.

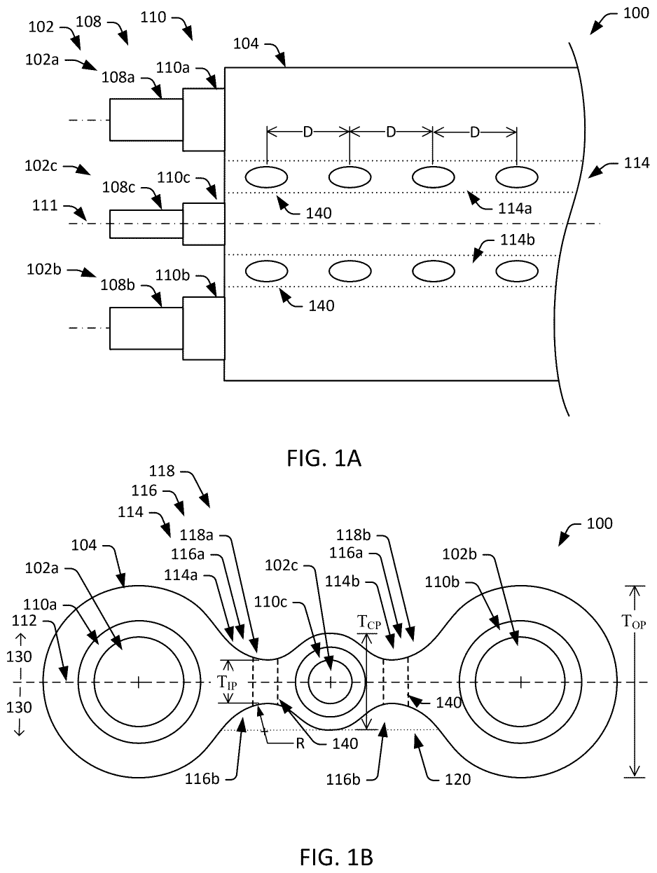

FIGS. 1A and 1B are diagrams that illustrate cut-away and end/cross-sectioned views, respectively, of a water-resistant (WR) parallel photovoltaic (PV) cable (“WRPPV cable”) 100 in accordance with one or more embodiments. Such a WRPPV cable 100 may be particularly well-suited for use as a PV cable for electric power transmission and distribution in damp or fluid-submerged environments.

In the illustrated embodiment, the WRPPV cable 100 includes the following: (1) three conductors (a “conductor set”) 102 (including a first conductor 102a, a second conductor 102b, and a third conductor 102c) and outer insulation (or “jacket”) 104 (e.g., a WR jacket) disposed about (e.g., fully around) the three conductors 102. The first conductor 102a includes a first conductor wire 108a and a first conductor inner insulation 110a disposed about the first conductor wire 108a. The second conductor 102b includes a second conductor wire 108b and a second conductor inner insulation 110b disposed about the second conductor wire 108b. The third conductor 102c includes a third conductor wire 108c and a third conductor inner insulation 110c disposed about the third conductor wire 108c. One, some, or all the conductors 102 may be insulated or not insulated (e.g., formed of a bare conductor wire 108). As described, in some embodiments, the inner insulation 110 is formed of a layer of cross-linked polyethylene (XLPE), and the jacket 104 is formed of a layer of polyethylene (PE) (e.g., water-resistant black PE) that is resistant to water penetration and absorption. Embodiments may include any suitable materials. For example, the jacket 104 may be formed of fire-resistant polyethylene (FR-PE), fire-resistant cross-linked polyethylene (FR-XLPE), ethylene propylene rubber (EPR), neoprene (chloroprene rubber), or thermoplastic elastomer (TPE), or the like.

In some embodiments, the first conductor 102a is a first phase conductor of the cable 100, the second conductor 102b is a second phase conductor of the cable 100, and the third conductor 102c is a ground conductor of the cable 100. For example, the first and second conductor wires 108a and 108b of the first and second conductors 102a and 102b may each provide a path for the transmission of electrical power (e.g., electrical power or control signals) across the WRPPV cable 100, and the third conductor wire 108c of the third conductor 102c may provide a path for the transmission of grounding loads (e.g., power overloads or grounding path loads) across the WR cable 100. In an embodiment where the WRPPV cable 100 is employed in a photovoltaic (PV) system to carry a direct current (DC) electrical load, the first and second conductor wires 108a and 108b (often referred to as “hot wires”) of the first and second phase conductors 102a and 102b may carry DC current, and the third conductor wire 108c (often referred to as the “earth wire” or “ground wire”) of the third conductor 102c may provide a safe path for current to flow in the event of a fault (such as a short circuit or ground fault), but is not intended to carry current during normal operation. Such a WR cable 100 may, for example, be employed to carry DC current to an inverter (that converts the DC from the solar panels to AC) to an electrical load or to a utility grid. Embodiments may include any suitable number of conductors, such as one, two, three, four, five, or more conductors.

In some embodiments, a conductor wire includes a solid or stranded conductor wire formed of an electrically conductive material, such as copper, copper plated with a thin layer of another metal (such as tin, gold or silver) or aluminum. For example, some or all of the first, second and third conductor wires 108a, 108b, and 108c may be an all-aluminum conductor (AAC) wire, an all-aluminum-alloy conductor (AAAC) wire, another aluminum alloy, or a copper wire. A conductor wire may be of a suitable size to transfer electrical power (e.g., electrical power and/or control signals) across the WRPPV cable 100. For example, one or both of the first and second conductor wires 108a and 108b may be size 2 American Wire Gauge (AWG) to 2000 thousand circular mils (kcmil or MCM). A grounding wire may be of a suitable size to transfer overload electrical signals (e.g., electrical power and/or control signals) across the WRPPV cable 100 to ground. For example, the third conductor wire 108c may be a size 4 American Wire Gauge (AWG) to 250 thousand circular mils (kcmil or MCM).

In some embodiments, insulation is a layer of an intermediate substrate that electrically or thermally insulates a wire. For example, one, some, or all of the first, second and third conductor inner insulations 110a, 110b, and 110c may be a layer of an intermediate substrate that electrically or thermally insulates respective ones of the first, second and third conductor wires 108a, 108b, and 108c from surrounding elements and the environment surrounding the WR cable 100. In some embodiments, insulation is formed of a cross-linked polyethylene material. For example, one, some, or all of the first, second and third conductor inner insulations 110a, 110b, and 110c may be formed of cross-linked polyethylene (XLPE). In some embodiments, inner insulation has a radial thickness that is suitable for the voltage rating of the cable/wires. In some embodiments, material forming inner insulation of a conductor is extruded about the circumference of the conductor. For example, one, some, or all of the first, second and third conductor inner insulations 110a, 110b, and 110c may be formed of XLPE material that is extruded about respective ones of the first, second and third conductor wires 108a, 108b, and 108c.

In some embodiments, outer insulation (or a “jacket”) physically protects and electrically or thermally insulates the conductors. For example, the outer insulation (or “jacket”) 104 disposed about the three conductors 102a, 102b and 102c may be formed of a layer of a water resistant (WR) black polyethylene that creates a jacketing that physically protects and electrically or thermally insulates three conductors 102a, 102b, and 102c from the environment surrounding the WR cable 100. In some embodiments, material forming a jacket of one or more conductors is extruded about the circumference of the conductor(s). For example, the jacket 104 may be formed of PE material that is extruded about the first, second and third conductors 102a, 102b and 102c. As described, the first, second and third conductors 102a, 102b and 102c may be arranged in a given configuration (e.g., a flat-parallel configuration) and the deposition of the jacket 104 about the conductors 102a, 102b, and 102c may fix the positions of the conductors 102a, 102b, and 102c in the given arrangement.

As illustrated, the conductors 102 may be arranged in a flat-parallel configuration that includes the conductors 102 positioned parallel to one another along their length, and with the third conductor 102c located between the first and second conductors 102a and 102b. In some embodiments, the flat-parallel configuration includes all three of the conductors 102a, 102b, and 102c, aligned parallel to one another and in a same/single or similar plane. For example, all three of the conductors 102a, 102b, and 102c (and their respective conductor wires 108a, 108b, and 108c) may be aligned (e.g., aligned in a direction transverse to a longitudinal axis 111 of the cable 100) with their axes/centers at least generally aligned along a common line or plane 112, as illustrated.

In some embodiments, the jacket 104 includes intermediate jacket portions extending between the conductors 102 and the associated portions of the jacket 104. For example, the extrusion of the PE material to form the jacket 104 about the conductors 102 arranged in the flat-parallel configuration may form intermediate jacket portions 114 formed of PE material that extend between adjacent ones of the conductors 102. As illustrated, this may include a first intermediate jacket portion 114a that extends between the portions of the jacket 104 disposed about the first conductor 102a and the third conductor 102c, and a second intermediate jacket portion 114b that extends between the portions of the jacket 104 disposed about the second conductor 102b and the third conductor 102c.

In some embodiments, the intermediate jacket portions 114 include a relatively thin cross-section (or “thickness”). For example, as illustrated, the extruded PE material extending between the conductors 102 may be shaped to form rounded depressions (or “valleys”) 116 in the intermediate jacket portions 114. As illustrated, this may create corresponding necked sections 118. As illustrated, the first and second intermediate jacket portions 114a and 114b may each include upper and lower depressions 116a and 116b that define corresponding first and second necked sections 118a and 118b. In some embodiments, the necked sections 118 have a thickness that is less than the thickness of the jacket disposed about the conductors 102. As illustrated, the necked sections 118a and 118b may have an thickness (TIP) (an “intermediate portion thickness” or “over jacket neck thickness”) that is less than a thickness (TCP) (a “central portion thickness” or a “over ground conductor jacket thickness”) of the central portion of the jacket 104 between the intermediate portions 114a and 114b (e.g., above and below the third conductor 102c) and that is less than a thickness (TOP) (an “outside portion thickness” or a “over phase conductor jacket thickness”) of the outer portions of the jacket 104 located outside of the intermediate portions 114a and 114b (e.g., above and below the first and second conductors 102a and 102b). In some embodiments, the depressions (or “valleys”) 116 are defined by a rounded or otherwise curved surface. For example, the depressions (or “valleys”) 116 may be rounded areas defined by a radius R (e.g., 0.25 inches). Although the illustrated embodiment shows both upper and lower depressions (or “valleys”) 116 formed on both sides of the jacket 100, embodiments may include various configurations. For example, the intermediate jacket portions 114a and 114b may each include an upper depression 116a and a relatively flat bottom (e.g., a flat surface extending across the underside of the intermediate jacket portion 114a or 114b, in place of the lower depression 116b), as illustrated by line 120.

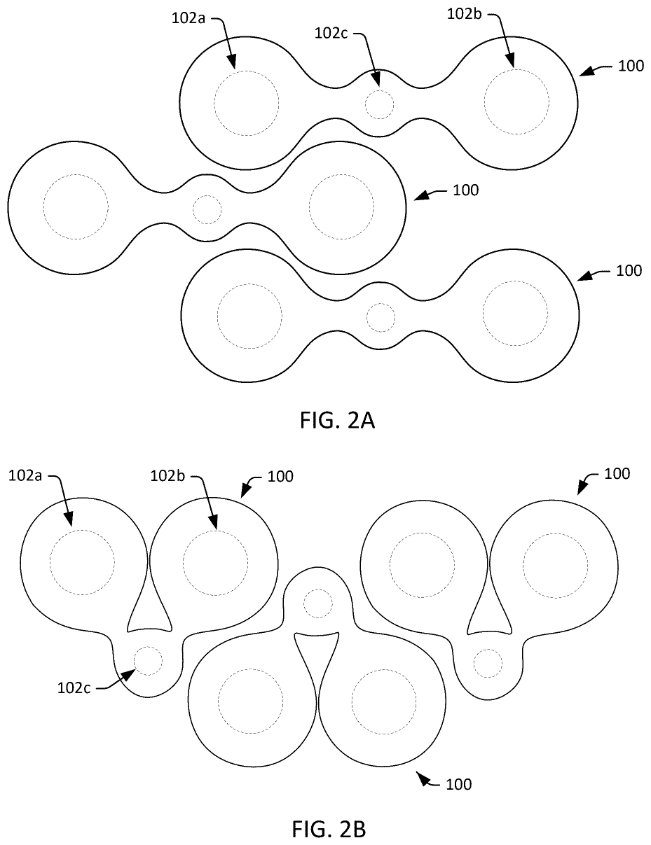

Incorporating a relatively thin central cross-section, including necked sections 118, may increase flexibility of the cable 100 (e.g., with the thinner cross-section facilitating bending of the cable in directions indicated by arrows 130, reduce the overall amount of jacket material (e.g., PE) used in the manufacture of the cable 100 (which can in turn reduce the weight of the jacket 104 and the cable 100 as a whole), and enhance the ability to place cables 100 adjacent to one another (e.g., stacking adjacent cables 100, with the relatively thick outer portions surrounding the conductors 102a and 102b being positioned in the depressions 116 of the relatively thin central portion of the jacket 104). FIGS. 2A and 2B are diagrams that illustrate example positioning of the cable 100 in accordance with one or more embodiments. FIG. 2A is a diagram that illustrates adjacent positioning (or “stacking”) of unfolded cables 100 in accordance with one or more embodiments. Such unfolded stacking may reduce the space needed to install cables 100. Further, the interlocking nature of the stacking may inhibit movement of cables 100 relative to one another, and, in turn, may help retain cables 100 in a desired installation configuration. FIG. 2B is a diagram that illustrates adjacent positioning (or “stacking”) of folded cables 100 in accordance with one or more embodiments. As illustrated, the necked portions of the cable 100 (e.g., the depressions 116a and 116b and associated necked cross-sectional areas 118a and 118b) may provide flexibility that enables the cable to be folded into the illustrated “triangle” or “Y” configuration, with the outer conductors 102a and 102b, urged toward one another, folded about the center conductor 102c. Such folding and stacking may reduce the space needed to install cables 100. Further, the interlocking nature of the folded stacking may inhibit movement of cables 100 relative to one another, and, in turn, may help retain cables 100 in a desired installation configuration.

In some embodiments, the intermediate jacket portions 114 include holes extending therethrough. For example, as illustrated, the intermediate jacket portions 114a and 114b may each include holes 140 extending laterally therethrough (e.g., holes 140 extending in a direction that is transverse to the flat line/plane 112). In some embodiments, the holes 140 include any suitable shape or pattern. For example, the holes 140 may include oval (e.g., elliptical), circular, square, rectangular, triangular, pentagonal, hexagonal, or other shapes. In some embodiments, the holes 140 of an intermediate portion 114 are spaced in a desired pattern. For example, as illustrated, the holes 140 may be aligned along the length of the intermediate jacket portions 114a and 114b and spaced at a regular distance (D) apart. The intermediate jacket portions 114 with holes 140 may be referred to as perforated intermediate jacket portions 114, each forming a webbing extending between respective ones of the two outside conductors 102a and 102b and the central conductor 102c. In some embodiments, only one of the intermediate jacket portions 114 includes holes 140. For example, the first intermediate portion 114a may have the illustrated holes 140 and the second intermediate portion 114b may not have holes 140. Such perforated intermediate portions 114 may reduce the overall amount of jacket material (e.g., PE) used in the manufacture of the cable 100 (which can in turn reduce the weight of the jacket 104 and the cable 100 as a whole), increase flexibility of the cable 100 (e.g., by reducing the cross-section of the cable 100), and enhance the case of installation, such as by inserting hooks, ties, screws, or other fasteners through the holes 140 to secure the cable 100 to a structure or other cables 100.

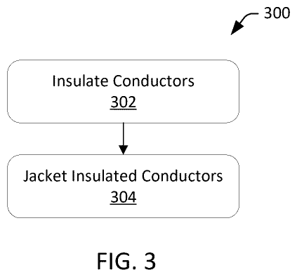

FIG. 3 is a flowchart diagram that illustrates a method of manufacturing a WRPPV cable 300 in accordance with one or more embodiments. In some embodiments, method 300 includes insulating conductors (block 302). This may include forming insulation about each of some or all of the conductor wires to be included in the cable. For example, insulating conductors may include disposing the inner insulations 110a, 110b, and 110c about respective ones of first and second conductor wires 108a, 108b, and 108c to form insulated conductors 102a, 102b, and 102c. In some embodiments, disposing insulation about a conductor wire includes extruding the insulation material about the conductor wire. For example, insulating conductors may include preparing (e.g., cleaning and pre-treating) each of the conductor wires 108a, 108b, and 108c and passing the conductor wires 108a, 108b, and 108c through a cross-linked polyethylene (XLPE) extruder that operates to coat the conductor wires 108a, 108b, and 108c with XLPE that forms the inner insulations 110a, 110b, and 110c about respective ones of first, second, and third conductor wires 108a, 108b, and 108c to form insulated conductors 102a, 102b, and 102c. The cross linking may, for example, be achieved by a suitable cross-linking processes, such as a peroxide method (a “thermochemical” cure) (e.g., where a peroxide compound is mixed with the XLPE before extrusion and once the extruded XLPE-coated wire passes through a heated zone (e.g., in a continuous vulcanization tube), the peroxide decomposes, initiating a chemical reaction that forms cross-links between the polymer chains), a silane method (a “moisture” cure) (e.g., silane-grafted XLPE is used, and after extrusion, the extruded XLPE-coated wire is exposed to moisture, either by steam or immersion in water, where the moisture activates the cross-linking reaction), or a radiation method (a “radiation” cure) (e.g., the extruded XLPE-coated wire is exposed to electron beam or gamma radiation, which causes cross-linking to occur by breaking polymer chains and forming new chemical bonds). After cross-linking, the wire may be cooled (e.g., by passing it through a water bath, which can helps solidify the XLPE insulation and ensures that it maintains its shape around the wire.

In some embodiments, method 300 includes jacketing insulated conductors (block 304). This may include arranging insulating conductors in a desired configuration, such as a flat-parallel configuration, and forming a jacket about the conductor wires to form a jacketed cable including the insulated conductor wires. Continuing with the above example, jacketing insulated conductors may include arranging the three conductors 102a, 102b, and 102c in a flat-parallel configuration (e.g., as shown in FIGS. 1A and 1B), and disposing a jacketing material about the three conductors 102a, 102b, and 102c in the flat-parallel configuration to form the outer jacket 104. This provides a WRPPV cable 100 including the insulated conductors 102a, 102b, and 102c embedded in the exterior jacket 104. In some embodiments, disposing jacketing material about the three conductors includes extruding the jacketing material about the conductors. For example, jacketing insulated conductors may include arranging the insulated conductors 102a, 102b, and 102c in the flat-parallel configuration and passing the set of arranged conductors 102a, 102b, and 102c through a polyethylene (PE) extruder that operates to coat the conductors 102a, 102b, and 102c with PE that forms the outer jacket 104. This provides a WRPPV cable 100 including XLPE insulated conductors 102a, 102b, and 102c embedded in a PE outer jacket 104. In some embodiments, the polyethylene (PE) extruder includes a die that operates to form the external profile of the outer jacket 104. For example, the die may provide a profile like that illustrated in FIG. 2, including the large/thick rounded outer jacket sections (disposed about the outer conductors 102a and 102b) and relatively small/thin central jacket section (including the rounded area disposed about the central conductor 102c and the intermediate jacket portions 114a and 114b including the depressions 116a and 116b and associated necked cross sectional areas 118a and 118b). After extrusion, the PE-coated cable may pass through a cooling system (e.g., a water bath or spray cooling), which rapidly cools the jacket 104 and solidifies it around the conductors 102 to form a PE jacketed cable. In some embodiments, jacketing insulated conductors includes forming holes in the jacket 104. Continuing with the above example, the jacketed insulated conductors may have holes added after extrusion by, punching (e.g. using a punch or hot needle), drilling (e.g., using a rotating drill bit), cutting (e.g., using a laser cutter), or etching (e.g., using a chemical solvent) the holes 140 in the intermediate jacket portions 114 of the PE jacket 104. This may provide a WRPPV cable 100 including XLPE insulated conductors 102a, 102b, and 102c embedded in a PE outer jacket 104 having necked intermediate jacket portions 114 with holes 140 formed therein. In such an embodiment, the XLPE insulation 110 may serve as a primary insulating layer, and the outer PE jacket 104 may add an extra layer of mechanical protection and environmental resistance, where, together, the XLPE insulation 110 and the outer PE jacket 104 create a durable, multi-layered insulation system for the WRPPV cable 100.

Such a process and configuration may provide a relatively flat, durable WRPPV cable 100 that is suitable for use in harsh conditions, such as UV exposure, extreme temperatures, moisture, fluid submersion, and the like that are often associated with photovoltaic power system locations. For example, it may provide a WRPPV cable 100 that is resistant to UV, extreme temperatures, chemicals, water, and mold/mildew, and can be stacked with other similar WRPPV cables, features a relatively small bend radius, and is relatively easy to secure and mount. Resistance to environmental conditions may, for example, enable the cable to be used in sun-exposed, hot, cold, and wet environments. The flat configuration may improve the heat dissipation condition with the maintained spacing between the conductors. A relatively small bend radius may facilitate handling of the WRPPV cable 100, bending it into desired shapes, and routing it along specific paths. A perforated intermediate portion 114 may help make the WRPPV cable 100 relatively lightweight and easier to install and secure, such as by inserting hooks, ties, screws, or other fasteners through the holes 140.

In some embodiments, the XLPE is a low to high density polyethylene (e.g., polyethylene having low density in the range of 0.910-0.925 g/cm³ or a density of greater than 0.941 g/cm³) containing cross-link bonds introduced into the polymer structure, changing the thermoplastic into a thermoset. For example, the XLPE may have a density of about 0.922 g/cm³, a melting point of about 265-284° C., a tensile strength of about 2480 pounds per square inch (psi), an elongation 450%, and 75% cross-linking.

In some embodiments, the jacket material is composed of PE and additives such as a cross-linking agent, additives that inhibit water intrusion or absorption, such as a hydrophobic agent (e.g., silane coupling agents that chemically bond with the polymer matrix to enhance water resistance), fluoropolymer-based additives (e.g., which can improve the hydrophobic properties of PE, making the surface less prone to water absorption), nanoclay or graphene-based additives (e.g., which can improve the impermeability of the PE by creating a tortuous path for water molecules), or other additives, such as antioxidants, fire retardants, or UV stabilizers.

Although certain embodiments are described for the purpose of illustration, the techniques can be employed for other embodiments. For example, although certain embodiments are described with regard to transmission lines, embodiments may be employed in other context, such as other types of electrical cables.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

As used throughout this application, the word “may” is used in a permissive sense (such as, meaning having the potential to), rather than the mandatory sense (such as, meaning must). The words “include,” “including,” and “includes” mean including, but not limited to. As used throughout this application, the singular forms “a”, “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A, B or C may refer to the element including A, B, C, A and B, A and C, B and C, or A, B and C.

What is claimed is:

1. A water-resistant jacketed paralleled electrical cable, comprising:
a conductor set comprising:
a first insulated conductor;
a second insulated conductor; and
a ground conductor,
the first insulated conductor, the second insulated conductor, and the ground conductor arranged in a flat-parallel configuration, with the ground conductor positioned between the first insulated conductor and the second insulated conductor; and
a water-resistant jacket disposed about the conductor set, the water-resistant jacket comprising:
a central portion proximate the ground conductor;
outer portions proximate the first insulated conductor and the second insulated conductor; and
intermediate portions extending between the central portion and the outer portions,
the central portion having a first thickness, the outer portions having a second thickness, and the first thickness being less than the second thickness, and
the intermediate portions comprising depressions defining necked sections between the central portion and the outer portions.

2. The cable of claim 1,
wherein the first insulated conductor and the second insulated conductor each comprise:
a conductor wire; and
an inner insulation layer formed of a cross-linked polyethylene (XLPE) disposed about the wire, and
wherein the water-resistant jacket is formed of polyethylene (PE) disposed about the first insulated conductor, the second insulated conductor, and the ground conductor.

3. The cable of claim 2, wherein the ground conductor comprises:
a conductor wire; and
an inner insulation layer formed of a cross-linked polyethylene (XLPE) disposed about the wire.

4. The cable of claim 2, wherein the PE is extruded about the XLPE.

5. The cable of claim 1, wherein the intermediate portions of the water-resistant jacket comprise holes disposed along a length of the intermediate portions.

6. An electrical cable, comprising:
a conductor set comprising:
a first insulated conductor;
a second insulated conductor; and
a ground conductor,
the first insulated conductor, the second insulated conductor, and the ground conductor arranged with the ground conductor positioned between the first insulated conductor and the second insulated conductor; and
a jacket disposed about the conductor set, the jacket comprising:
a central portion proximate the ground conductor;
outer portions proximate the first insulated conductor and the second insulated conductor; and
intermediate portions extending between the central portion and the outer portions,
the central portion having a first thickness, the outer portions having a second thickness, and the first thickness being less than the second thickness, and
the intermediate portions comprising depressions defining necked sections between the central portion and the outer portions.

7. The cable of claim 6,
wherein the first insulated conductor and the second insulated conductor each comprise:
a conductor wire; and
an inner insulation layer formed of a cross-linked polyethylene (XLPE) disposed about the wire, and
wherein the water-resistant jacket is formed of polyethylene (PE) disposed about the first insulated conductor, the second insulated conductor, and the ground conductor.

8. The cable of claim 7, wherein the ground conductor comprises:
a conductor wire; and
an inner insulation layer formed of a cross-linked polyethylene (XLPE) disposed about the wire.

9. The cable of claim 7, wherein the PE is extruded about the XLPE.

10. The cable of claim 6, wherein the intermediate portions of the jacket comprise holes disposed along a length of the intermediate portions.

11. The cable of claim 6, wherein the ground conductor comprises an insulated ground wire.

12. The cable of claim 6, wherein the jacket comprises a water-resistant jacket.

13. A method of forming an electrical cable comprising:
insulating a first conductor wire to form a first insulated conductor;
insulating a second conductor wire to form second insulated conductor; and
arranging the first insulated conductor, the second insulated conductor, and a ground conductor with the ground conductor positioned between the first insulated conductor and the second insulated conductor to form a conductor set; and
disposing a jacket about the conductor set, the jacket comprising:
a central portion proximate the ground conductor;
outer portions proximate the first insulated conductor and the second insulated conductor; and
intermediate portions extending between the central portion and the outer portions,
the central portion having a first thickness, the outer portions having a second thickness, and the first thickness being less than the second thickness, and
the intermediate portions comprising depressions defining necked sections between the central portion and the outer portions.

14. The method of claim 13,
wherein insulating the first conductor wire comprises disposing cross-linked polyethylene (XLPE) about the first conductor wire,
wherein insulating the second conductor wire comprises disposing XLPE about the second conductor wire, and
wherein disposing a jacket about the conductor set comprises disposing polyethylene (PE) about the first insulated conductor, the second insulated conductor, and the ground conductor.

15. The method of claim 14, wherein the ground conductor comprises:
a conductor wire; and
an inner insulation layer formed of a cross-linked polyethylene (XLPE) disposed about the wire.

16. The method of claim 14, wherein the PE is extruded about the XLPE.

17. The method of claim 13, further comprising forming holes along a length of the intermediate portions.

18. The method of claim 13, wherein the ground conductor comprises an insulated ground wire.

19. The method of claim 13, wherein the jacket comprises a water-resistant jacket.
